(19) United States
(12) Patent Application Publication
(10) Pub. No.: US 2013/0198213 A1
(43) Pub. Date: Aug. 1, 2013

(54) INFORMATION PROCESSING APPARATUS, INFORMATION PROCESSING METHOD, AND PROGRAM

(71) Applicant: Sony Corporation, Tokyo (JP)

(72) Inventors: Yasushi Ikeda, Kanagawa (JP); Takafumi Azuma, Tokyo (JP); Tsunemitsu Takase, Tokyo (JP)

(73) Assignee: SONY CORPORATION, Tokyo (JP)

(21) Appl. No.: 13/747,630

(22) Filed: Jan. 23, 2013

(30) Foreign Application Priority Data
Jan. 31, 2012 (JP) 2012-017934

(51) Int. Cl. G06F 17/30

(52) U.S. Cl. CPC G06F 17/30064
USPC 707/758

(57) ABSTRACT

There is provided an information processing apparatus including a reference position determination unit configured to determine a reference position on a time axis in content reproduction at time intervals corresponding to a reproduction speed of content, a search range setting unit configured to set a search range on the time axis based on the reference position and a selection unit configured to select a display picture to be displayed in the content reproduction based on metadata of the content in each search range.

### BACKGROUND

The present disclosure relates to an information processing apparatus, an information processing method, and a program.

Recently, an amount of content treated by users has increased. Incidentally, a time available for users to view and listen to content is limited. Thus, various methods for allowing users to efficiently view and listen to content have been proposed. For example, in Japanese Patent Application Publication No. 2006-164337, a high-speed reproduction method based on priority of entry point has been proposed.

### SUMMARY

However, a method considering the simultaneous pursuit of searchability to search for a desired viewing/listening position in content and viewability/listenability of content has not been proposed.

According to an embodiment of the present disclosure, there is provided an information processing apparatus including a reference position determination unit configured to determine a reference position on a time axis in content reproduction at time intervals corresponding to a reproduction speed of content, a search range setting unit configured to set a search range on the time axis based on the reference position, and a selection unit configured to select a display picture to be displayed in the content reproduction based on metadata of the content in each search range.

Further, according to an embodiment of the present disclosure, there is provided an information processing method including determining a reference position on a time axis in content reproduction at time intervals corresponding to a reproduction speed of content, setting a search range on the time axis based on the reference position, and selecting a display picture to be displayed in the content reproduction based on metadata of the content in each search range.

Further, according to an embodiment of the present disclosure, there is provided a program for causing a computer to function as an information processing apparatus, which includes a reference position determination unit configured to determine a reference position on a time axis in content reproduction at time intervals corresponding to a reproduction speed of content, a search range setting unit configured to set a search range on the time axis based on the reference position, and a selection unit configured to select a display picture to be displayed in the content reproduction based on metadata of the content in each search range.

Further, according to an embodiment of the present disclosure, there is provided an information processing apparatus including a predetermined time interval setting unit configured to set a time interval on a time axis of video data based on a reproduction speed of the video data, a search range setting unit configured to set a plurality of search ranges on the time axis of the video data based on the predetermined time interval, and a reproduction unit configured to sequentially reproduce the video data present in the plurality of search ranges based on metadata of the video data.

Further, according to an embodiment of the present disclosure, there is provided an information processing method including setting a predetermined time interval on a time axis of video data based on a reproduction speed of the video data, setting a plurality of search ranges on the time axis of the video data based on the predetermined time interval, and sequentially reproducing the video data present in the plurality of search ranges based on metadata of the video data.

According to the embodiments of the present disclosure described above, an information processing apparatus, an information processing method, and a program for performing high-speed reproduction considering the simultaneous pursuit of searchability to search for a desired viewing/listening position in content and viewability/listenability of content are provided.

### BRIEF DESCRIPTION OF THE DRAWINGS

FIG. 1 is an explanatory diagram illustrating an overview of an information processing apparatus in accordance with an embodiment of the present disclosure;

FIG. 2 is a block diagram illustrating a functional configuration of the information processing apparatus in accordance with the same embodiment;

FIG. 3 is an explanatory diagram illustrating settings of a reference position and a search range in the information processing apparatus in accordance with the same embodiment;

FIG. 4 is an explanatory diagram illustrating an example of a determination standard of a display position in the information processing apparatus in accordance with the same embodiment;

FIG. 5 is an explanatory diagram illustrating another example of the determination standard of the display position in the information processing apparatus in accordance with the same embodiment;

FIG. 6 is an explanatory diagram illustrating another example of the determination standard of the display position in the information processing apparatus in accordance with the same embodiment;

FIG. 7 is an explanatory diagram illustrating another example of the determination standard of the display position in the information processing apparatus in accordance with the same embodiment;

FIG. 8 is an explanatory diagram illustrating a continuous display section in a display picture determination process of the information processing apparatus in accordance with the same embodiment;

FIG. 9 is an explanatory diagram illustrating a group of pictures (GOP) structure of moving-picture content data to be reproduced by the information processing apparatus in accordance with the same embodiment;

FIG. 10 is a table illustrating an example of display pictures of the continuous display section in the display picture determination process of the information processing apparatus in accordance with the same embodiment;

FIG. 11 is a diagram illustrating a relationship between a display position and a display picture in a display picture determination of the information processing apparatus in accordance with the same embodiment;

FIG. 12 is a flowchart illustrating an example of a display picture determination operation of the information processing apparatus in accordance with the same embodiment;

FIG. 13 is an explanatory diagram illustrating an example of a situation occurring when reproduction at a normal reproduction speed is started from high-speed reproduction;

FIG. 14 is an explanatory diagram illustrating solution 1 for resolving a situation illustrated in FIG. 13;

FIG. 15 is an explanatory diagram illustrating solution 2 for resolving a situation illustrated in FIG. 13;

FIG. 16 is an explanatory diagram illustrating a situation in which reproduction at a normal reproduction speed is started from high-speed reproduction in the information processing apparatus in accordance with the same embodiment; and

FIG. 17 is a block diagram illustrating an example of a hardware configuration when the information processing apparatus is a portable phone in accordance with an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Description will be given in the following order.
1. Configuration
2. Determination of Display Picture
3. Operation Example
4. Examples of Effects
5. Modified Examples

### 1. CONFIGURATION

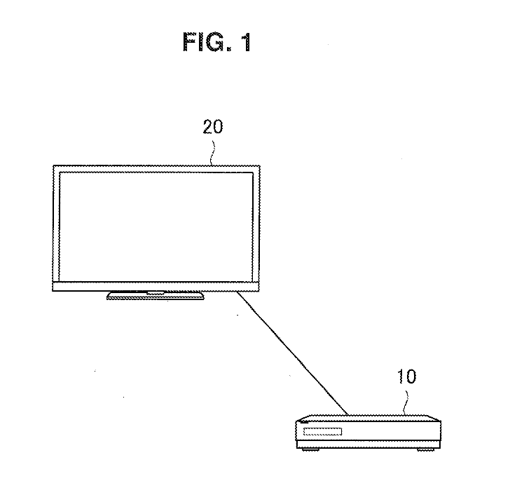

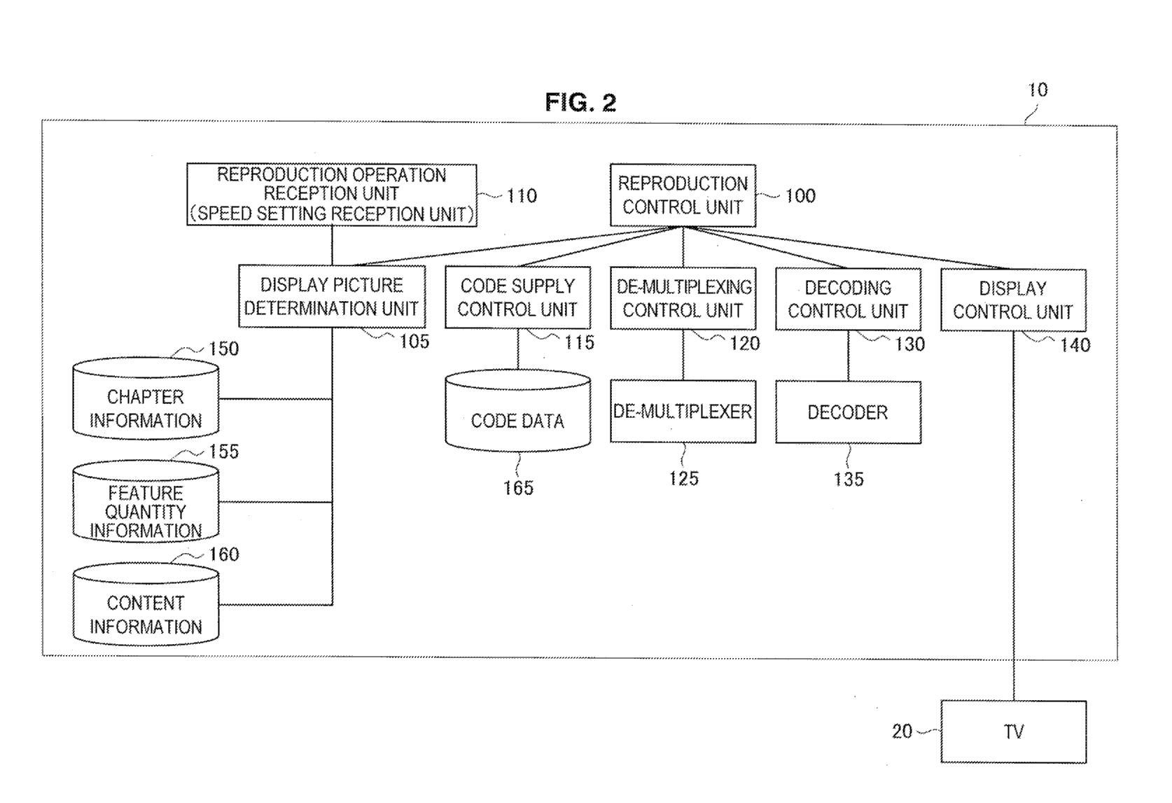

First, a configuration of an information processing apparatus in accordance with an embodiment of the present disclosure will be described with reference to FIGS. 1 and 2. FIG. 1 is an explanatory diagram illustrating an overview of the information processing apparatus in accordance with the embodiment of the present disclosure. FIG. 2 is a block diagram illustrating a functional configuration of the information processing apparatus in accordance with the same embodiment.

As illustrated in FIG. 1 in this embodiment, an example in which a recording/reproducing apparatus 10 connected to a television receiver (TV) 20 reproduces recorded content at a high speed will be described.

Referring to FIG. 2, the recording/reproducing apparatus 10 mainly includes a reproduction control unit 100, a display picture determination unit 105, a reproduction operation reception unit 110, a code supply control unit 115, a de-multiplexing control unit 120, a de-multiplexer 125, a decoding control unit 130, a decoder 135, a display control unit 140, a chapter information storage unit 150, a feature quantity information storage unit 155, a content information storage unit 160, and a code data storage unit 165.

### (Reproduction Control Unit 100)

The reproduction control unit 100 can control an operation of reproducing video content by controlling the display picture determination unit 105, the code supply control unit 115, the de-multiplexing control unit 120, the decoding control unit 130, and the display control unit 140.

### (Display Picture Determination Unit 105)

The display picture determination unit 105 has a function of determining a picture displayed in high-speed reproduction based on a reproduction speed of high-speed reproduction set by a user's operation received by the reproduction operation reception unit 110. The high-speed reproduction used here, for example, is a concept including fast forward reproduction and fast rewind reproduction. The display picture determination unit 105 is an example of a reference position determination unit, which determines a reference position in content at time intervals corresponding to a reproduction speed, a search range setting unit, which sets a search range on a time axis based on the reference position, and a selection unit, which selects a display picture based on metadata of the content in the search range.

After determining the reference position on the time axis at the time intervals corresponding to the content reproduction speed, the display picture determination unit 105 selects the display picture from the search range by setting the search range based on the reference position. The display picture determination unit 105 further increases an interval of the reference position when the reproduction speed is greater. In addition, the display picture determination unit 105 selects the display picture from the search range based on the metadata of the content to be reproduced. An example of the metadata used here is a feature quantity or the like obtained by analyzing at least one of information of a chapter point assigned by a user, a content provider, or the like and a picture and audio of the content. In addition, the search range is set in the vicinity of the reference position. For example, the search range may be a range including the reference position. In addition, the search range may be a range based on the reference position. In the normal high-speed reproduction, display pictures are selected at time intervals corresponding to a reproduction speed. However, if display pictures are simply selected at equal intervals, it is difficult to find a scene the user desires to view by selecting a display picture without determining details of content. On the other hand, it is difficult to find a position the user desires to view from the entire content only by simply selecting a display picture based on the metadata when metadata biased toward the time axis has been arranged. In this embodiment, a reference position is determined at time intervals corresponding to a reproduction speed at which content is reproduced at a high speed, and a position of a display picture is corrected so that a more meaningful picture is displayed based on metadata in the vicinity of the reference position.

In addition, a size of the search range may be a size corresponding to a reproduction speed of high-speed reproduction. The display picture determination unit 105 may further increase the size of the search range when the reproduction speed is greater. In addition, the display picture determination unit 105 may select a plurality of display pictures from one search range. Details of a method in which the display picture determination unit 105 determines a display picture will be described later. The display picture determination unit 105 can determine the display picture by determining a supply range in which data is actually supplied to the decoder 135.

### (Reproduction Operation Reception Unit 110)

The reproduction operation reception unit 110 has a function of receiving the user's reproduction operation. The reproduction operation used here can include an operation of selecting content to be reproduced, a reproduction start operation, an operation of setting a reproduction speed (for example, 10 times speed, 30 times speed, or 120 times speed) (including a setting of a reproduction direction), and a reproduction stop operation. The reproduction operation reception unit 110 can supply the set reproduction speed to the display picture determination unit 105.

### (Code Supply Control Unit 115)

If a supply range is determined by the display picture determination unit 105, the code supply control unit 115, for example, reads code data compressed by a predetermined Moving Picture Experts Group (MPEG) codec or the like onto a memory.

### (De-Multiplexing Control Unit 120)

The de-multiplexing control unit 120 de-multiplexes code data using the de-multiplexer 125. Here, the code data is data obtained by multiplexing data such as a video and an audio. Thus, the de-multiplexing control unit 120 can separate the video, the audio, and the like by de-multiplexing the code data. In high-speed reproduction in which only video data is used, the de-multiplexing control unit 120 discards data other than the video.

### (De-Multiplexer 125)

The de-multiplexer 125 de-multiplexes code data according to control of the de-multiplexing control unit 120.

### (Decoding Control Unit 130)

The decoding control unit 130 performs a process of decoding the de-multiplexed video data. The decoding control unit 130 performs the decoding process using the decoder 135. In high-speed reproduction for displaying only an intra picture (I-picture), the decoding control unit 130 can discard data other than the I-picture.

### (Decoder 135)

The decoder 135 can perform a process of decoding de-multiplexed video data according to control of the decoding control unit 130.

### (Display Control Unit 140)

The display control unit 140 has a function of controlling a screen display of the TV 20. The display control unit 140 processes an I-picture, which is a decoded display picture, to be displayed on a screen of the TV 20.

### (Storage Unit)

In FIG. 2, a chapter information storage unit 150, a feature quantity information storage unit 155, a content information storage unit 160, and a code data storage unit 165 are illustrated. These storage units are data storage apparatuses, and can include a storage medium, a recording apparatus, which records data on the storage medium, a reading apparatus, which reads data from the storage medium, a deleting apparatus, which deletes data recorded on the storage medium, and the like. Here, for example, a non-volatile memory such as a flash memory, a magnetoresistive random access memory (MRAM), a ferroelectric random access memory (FeRAM), a phase change random access memory (PRAM), or an electrically erasable and programmable read only memory (EEPROM), a magnetic recording medium such as a hard disk drive (HDD), and an optical recording medium such as a digital versatile disc (DVD) may be used as the storage medium.

The chapter information storage unit 150, the feature quantity information storage unit 155, the content information storage unit 160, and the code data storage unit 165 may be implemented by the same storage medium, and at least some may be implemented by separate storage media. In addition, the information may be stored in a storage unit embedded in the recording/reproducing apparatus 10, and may be stored in an external apparatus (not illustrated). When the recording/reproducing apparatus 10 uses the information stored in the external apparatus, the information may be acquired via a communication unit (not illustrated).

An example of a function of the recording/reproducing apparatus 10 in accordance with this embodiment has been described above. The above-described elements may be configured using general-purpose members or circuits and may also be configured by hardware specialized for functions of the elements. In addition, calculation apparatuses such as one or more central processing units (CPUs) may execute the functions of the elements by executing a control program describing a processing procedure of implementing the functions. Accordingly, it is possible to appropriately change a configuration to be used according to a technical level when this embodiment is performed.

It is possible to create a computer program for implementing the functions of the recording/reproducing apparatus 10 in accordance with this embodiment as described above and implement the computer program in a personal computer (PC) or the like. In addition, a computer-readable recording medium storing the above-described computer program can also be provided. An example of the recording medium is a magnetic disk, an optical disc, a magneto-optical disc, or a flash memory. In addition, the above-described computer program may be distributed, for example, via a network, without using a recording medium.

### 2. DETERMINATION OF DISPLAY PICTURE

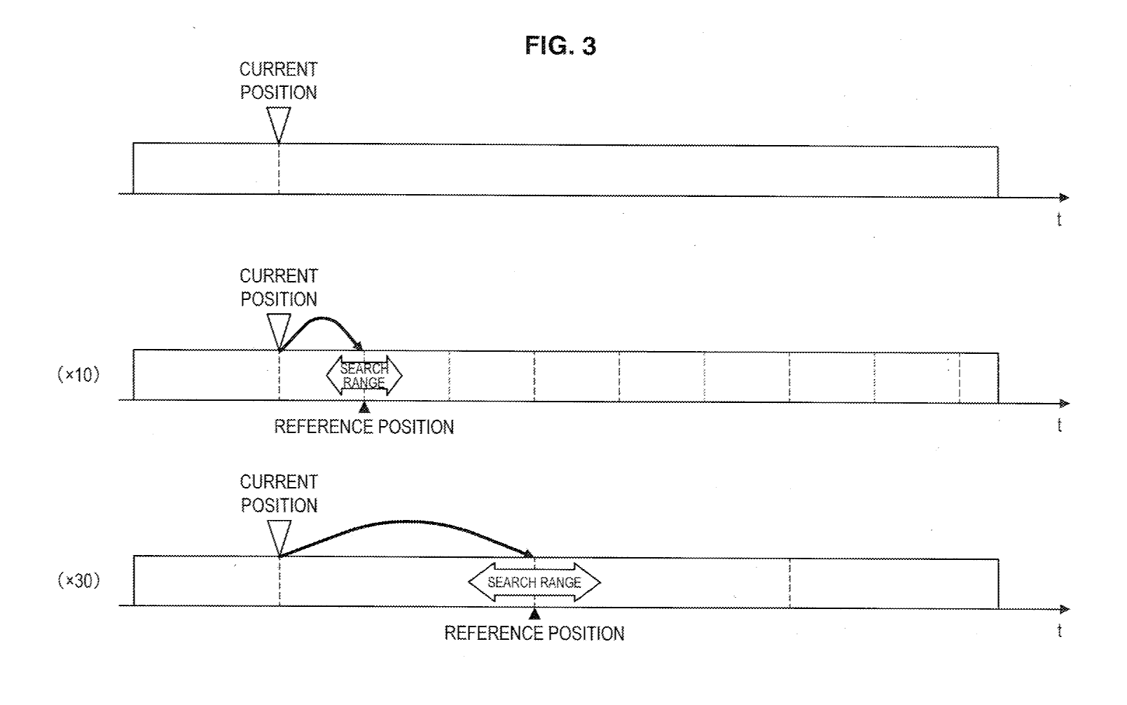

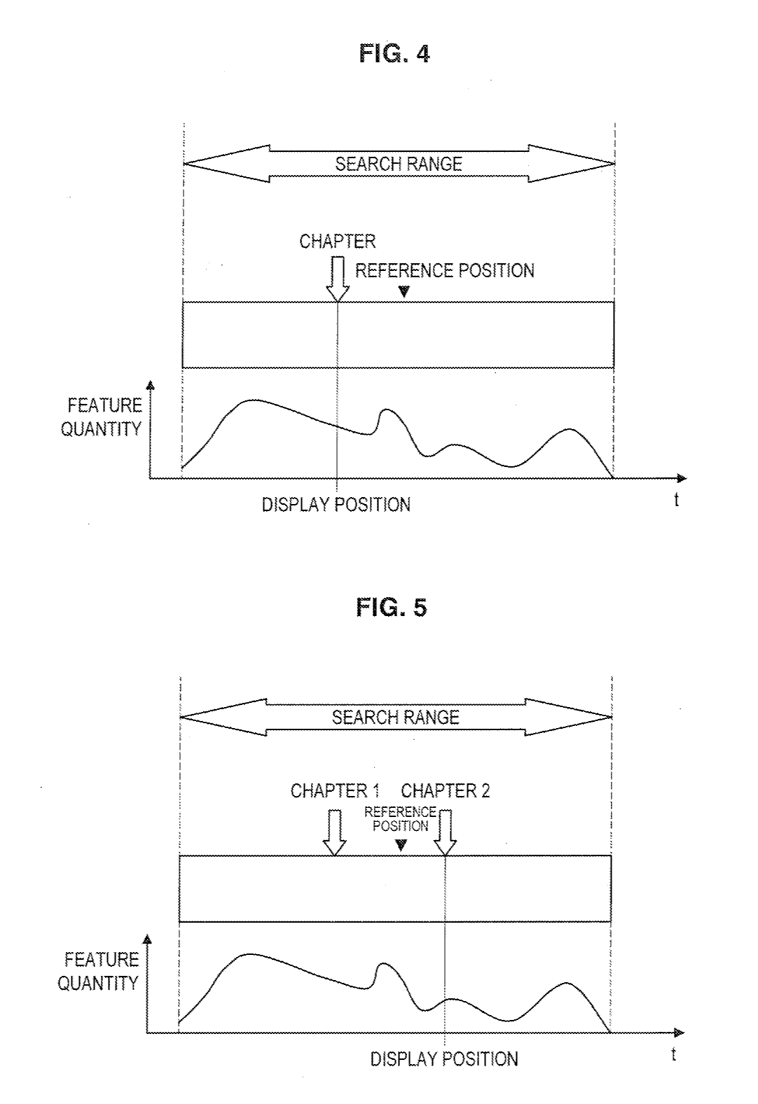

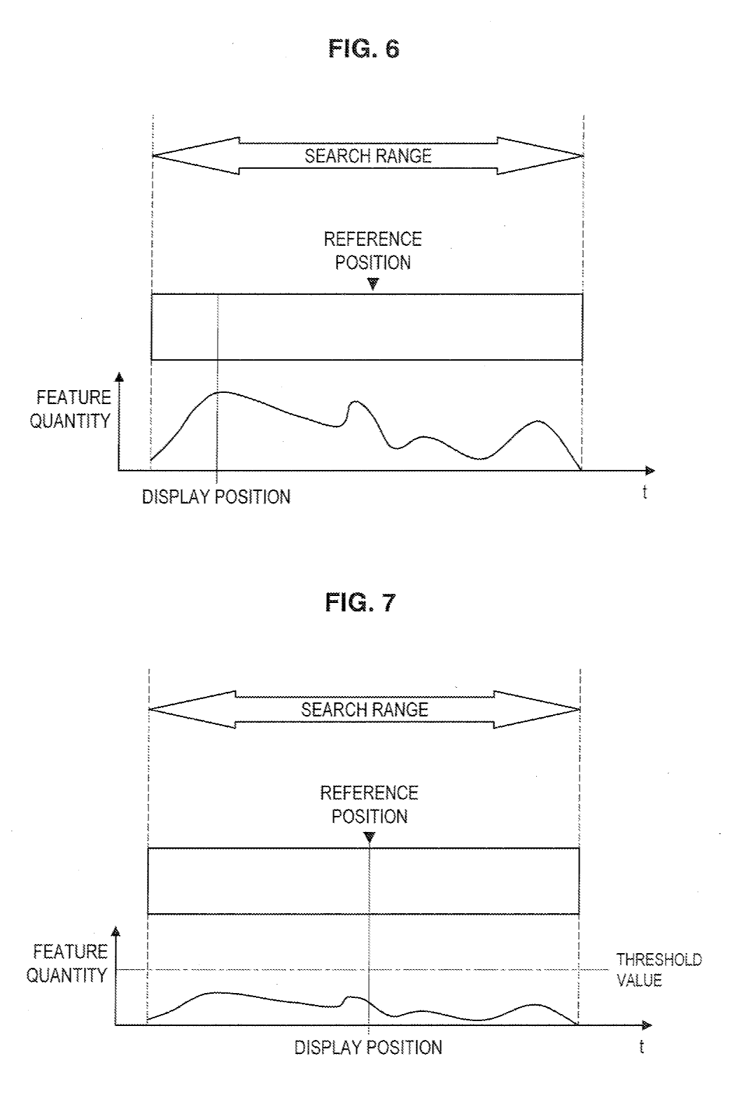

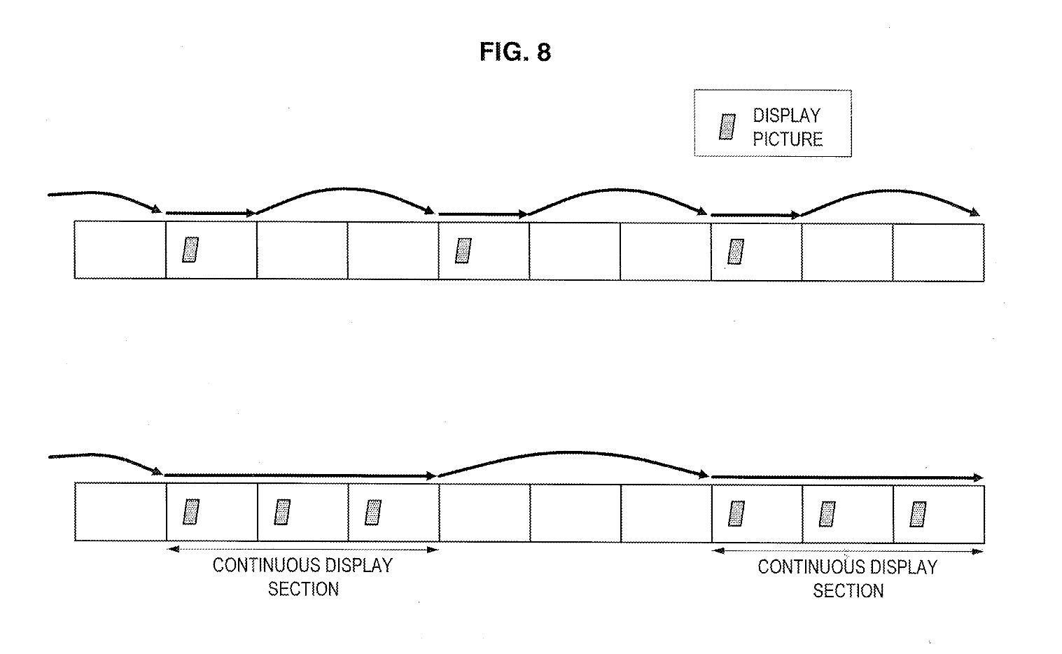

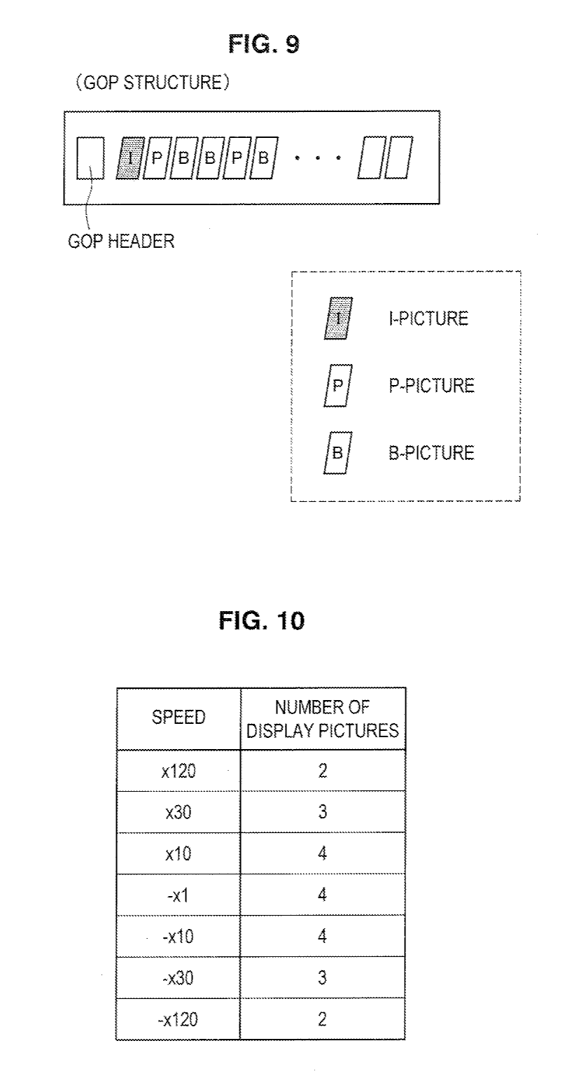

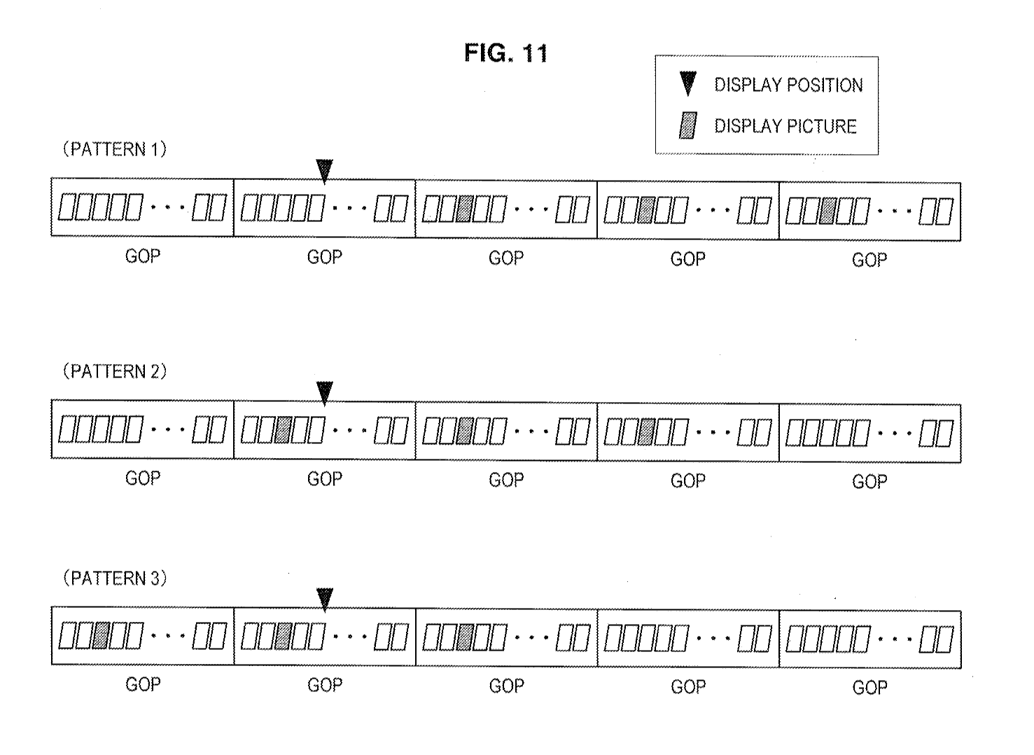

Next, the determination of the display picture in the information processing apparatus in accordance with the embodiment of the present disclosure will be described in detail with reference to FIGS. 3 to 11. FIG. 3 is an explanatory diagram illustrating settings of a reference position and a search range in the information processing apparatus in accordance with the same embodiment. FIG. 4 is an explanatory diagram illustrating an example of a determination standard of a display position in the information processing apparatus in accordance with the same embodiment. FIG. 5 is an explanatory diagram illustrating another example of the determination standard of the display position in the information processing apparatus in accordance with the same embodiment. FIG. 6 is an explanatory diagram illustrating another example of the determination standard of the display position in the information processing apparatus in accordance with the same embodiment. FIG. 7 is an explanatory diagram illustrating another example of the determination standard of the display position in the information processing apparatus in accordance with the same embodiment. FIG. 8 is an explanatory diagram illustrating a continuous display section in a display picture determination process of the information processing apparatus in accordance with the same embodiment. FIG. 9 is an explanatory diagram illustrating a GOP structure of moving-picture content data to be reproduced by the information processing apparatus in accordance with the same embodiment. FIG. 10 is a table illustrating an example of display pictures of the continuous display section in the display picture determination process of the information processing apparatus in accordance with the same embodiment. FIG. 11 is a diagram illustrating a relationship between a display position and a display picture in a display picture determination of the information processing apparatus in accordance with the same embodiment.

### (Settings of Reference Position and Search Range)

The display picture determination unit 105 can set a reference position of content at time intervals corresponding to a reproduction speed of high-speed reproduction. This interval may be set to be greater when the reproduction speed is greater. The display picture determination unit 105 sets a search range based on the reference position. The search range is set in the vicinity of the reference position. For example, the search range may be a range including the reference position. In addition, the search range may be a range based on the reference position. In addition, the search range may be a range having a size corresponding to the reproduction speed. Specifically, the search range may be a wider range when the reproduction speed is greater. Even when a display position within the search range to be described later is set to a position different from the reference position, the next reference position is set at predetermined time intervals from the reference position that is most recently set so that the reproduction speed is constantly kept to a certain extent.

The case of FIG. 3 will be described as a specific example. A current position in content is illustrated in the top view of FIG. 3. Here, the current position, for example, is a start position on a time axis of content to be reproduced. As another example, it is possible to use a point in time at which content is currently being reproduced in a current position. For example, the current position may be a point in time at which a reproduction speed of content has been changed. The display picture determination unit 105 determines the reference position at intervals corresponding to the speed from the current position. For example, a reference position and a search range in the case of 10 times speed are illustrated in the middle view of FIG. 3. In addition, a reference position and a search range in the case of 30 times speed are illustrated in the bottom view of FIG. 3. In the case of 30 times speed as described above, a reference position is determined at greater intervals than in the case of 10 times speed. When the reference position is determined, then the display picture determination unit 105 sets the search range based on the reference position. In the example of FIG. 3, the search range is a predetermined range based on the reference position. A size of the search range may be determined based on a reproduction speed. In the example of FIG. 3, the size of the search range at 30 times speed is greater than the size of the search range at 10 times speed.

### (Determination of Display Position)

The display picture determination unit 105 can determine a display position within a set search range based on metadata of content. When a chapter is set within the search range, for example, as illustrated in FIG. 4, the display picture determination unit 105 can designate a position of the chapter as the display position. In addition, when a plurality of chapters (chapters 1 and 2) are set within one search range as described in FIG. 5, the display picture determination unit 105 may designate a position of a chapter positioned closer to the reference position as the display position. In chapters 1 and 2 of FIG. 5, chapter 2 is close to the reference position. Thus, in this case, a point in time of chapter 2 is designated as the display position. Alternatively, although not illustrated, when a plurality of chapters are set within one search range, the display picture determination unit 105 may designate a position of a chapter selected based on a feature quantity among the plurality of chapters as the display position.

In addition, as illustrated in FIG. 6, when a chapter is not set within the search range, the display picture determination unit 105 may determine a display position based on a feature quantity. For example, the display picture determination unit 105 can designate a position of a largest feature quantity as the display position. Incidentally, it is not necessarily appropriate to designate the position of the largest feature quantity as the display position. For example, as illustrated in FIG. 7, the feature quantity may be decreased in the search range. At this time, the position of the largest feature quantity in the search range is not necessarily a picture of a characteristic scene. The display picture determination unit 105 can set the reference position to the display position when the feature quantity is not greater than a threshold value by setting the threshold value of the feature quantity.

### (Selection of Display Picture Based on Display Position)

When a continuous display section is provided as illustrated in the bottom view of FIG. 8 rather than when only one display picture is displayed at every time interval from within one search range as illustrated in the top view of FIG. 8, there is an advantage in that visibility of content is high. For example, a caption such as news can be read by setting the continuous display section. In addition, it is easy to recognize details of a displayed scene by setting the continuous display section in content such as a drama. In addition, it is possible to recognize a time direction of high-speed reproduction by setting the continuous display section.

Here, a content compression standard is assumed to be MPEG. In FIG. 8, a rectangle including a display picture has a GOP structure illustrated in FIG. 9. Referring to FIG. 9, a GOP can include a GOP header, an I-picture, a predictive picture (P-picture), and a bi-directional predictive picture (B-picture). The I-picture is an intra-frame coded picture and is not predictive. The I-picture is obtained by compressing only one picture, and has a low compression rate, but has high precision. In addition, it is possible to restore a picture by only information of the I-picture. In addition, the P-picture is an inter-frame forward predictive coded picture, and is a picture using motion compensation prediction in one direction in which a previous frame is referred to. The P-picture can implement equivalent picture quality in a smaller capacity than the I-picture. In addition, the B-picture is a bi-directional predictive coded picture, and is a picture using bi-directional motion compensation prediction in two directions in which the previous and next frames are referred to. The B-picture can implement equivalent picture quality in a smaller capacity than the I- and P-pictures. However, it is difficult to independently restore pictures from the P- and B-pictures if other frames are not referred to. As described above, it is possible to independently restore a picture from the I-picture. Each GOP includes at least one I-picture. Here, it is desirable to use the I-picture in the display picture.

Description will continue with reference back to FIG. 8. The number of display pictures to be displayed in a continuous display section may be determined, for example, based on a reproduction speed of high-speed reproduction. An example of the number of display pictures corresponding to a reproduction speed will be described with reference to FIG. 10. For example, when the reproduction is performed at 120 times speed and −120 times speed, the number of display pictures of the continuous display section may be 2. In addition, when the reproduction is performed at 30 times speed and −30 times speed, the number of display pictures of the continuous display section may be 3. In addition, when the reproduction is performed at 10 times speed, −1 times speed, and −10 times speed, the number of display pictures of the continuous display section may be 4. As described above, it is possible to improve the viewer's perception of intuitive speed-up by further decreasing the number of display pictures when a reproduction speed of high-speed reproduction is higher. In addition, it is possible to improve the viewer's perception of intuitive video visibility by further increasing the number of display pictures when a reproduction speed of high-speed reproduction is lower.

Although the display position determination method has been described above, a display position is determined regardless of a GOP structure because a chapter position and a point of a large feature quantity are assigned regardless of the GOP structure. That is, a picture corresponding to the display position is not necessarily the I-picture. A method of determining a display picture from a display position will be described here with reference to FIG. 11. Here, the case in which the number of display pictures of the continuous display section is 3 will be described here. For example, as illustrated in pattern 1, the display picture determination unit 105 may designate I-pictures included in three GOPs immediately after the display position as display pictures. In addition, as illustrated in pattern 2, the display picture determination unit 105 may designate I-pictures included in three GOPs from a GOP including the display position as display pictures. In addition, as illustrated in pattern 3, the display picture determination unit 105 may designate I-pictures included in three previous and next GOPs based on the display position as display pictures. For example, a point or chapter of a large feature quantity is usually set to a point in time at which a scene is switched. In view of this, a predetermined section may be displayed after a scene has been switched as in pattern 1. In addition, a form in which a scene is switched as in pattern 3 may be displayed.

As described above, the display picture determination unit 105 sets a reference position at time intervals corresponding to a reproduction speed in content, and sets a search range based on the reference position. When a picture corresponding to the reference position has been directly displayed, high-speed reproduction in which details of content are displayed at predetermined time intervals can be performed. However, here, a displayed picture is not necessarily appropriate as a picture that is representative of a scene in the vicinity of the picture. The display picture determination unit 105 can determine the display position by determining whether or not there is another appropriate picture as the display picture in the search range. Here, the display picture determination unit 105 can determine the display position based on metadata of content in the search range. Thereby, the reference position is determined at predetermined time intervals corresponding to a reproduction speed and the display position is determined in the vicinity thereof, so that a more important scene for a viewer can be displayed without impairing a sense of position on the time axis of content. Because a picture corresponding to the display position may not be data from which a picture can be independently restored, the display picture determination unit 105 can determine a supply range, which is a data range in which data is supplied in units of GOPs based on the display position as described above, and use I-pictures included in the GOPs as display pictures. That is, the display picture determination unit 105 determines the display pictures by determining the supply range.

### 3. OPERATION EXAMPLE

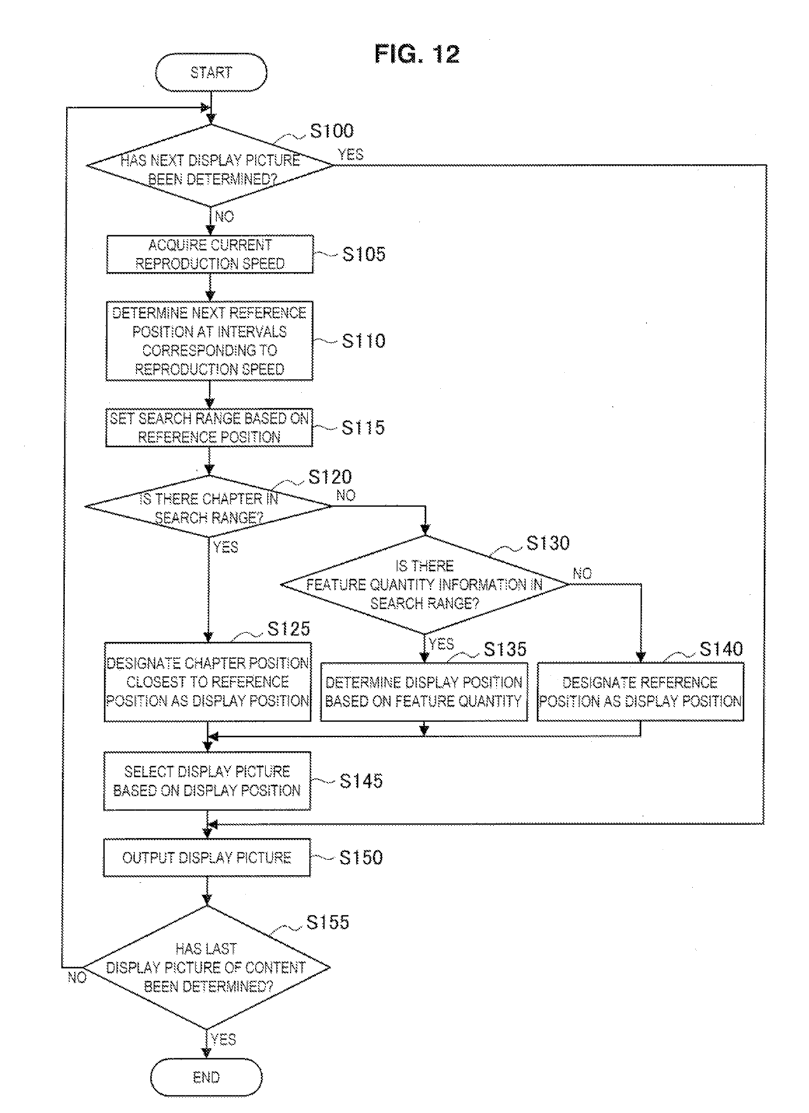

Next, an example of a display picture determination operation of the information processing apparatus in accordance with the embodiment of the present disclosure will be described with reference to FIG. 12. FIG. 12 is a flowchart illustrating the example of the display picture determination operation of the information processing apparatus in accordance with the same embodiment.

First, the display picture determination unit 105 determines whether or not the next display picture is determined (S100). For example, here, the case in which the next display picture is determined includes the case in which the continuous display section is in reproduction. In this case, the display picture determination unit 105 designates an I-picture included in the next GOP as the display picture.

On the other hand, when no next display picture is determined, then the display picture determination unit 105 acquires a current reproduction speed (S105). The display picture determination unit 105 determines the next reference position at time intervals corresponding to the acquired reproduction speed (S110). Here, the display picture determination unit 105 can determine the next reference position at time intervals corresponding to the reproduction speed from a previous reference position. When the reference position is initially determined, the display picture determination unit 105 can determine the next reference position at time intervals corresponding to the reproduction speed from a current position. There is a difference between the reference position and the position of the display picture. Thus, as an internal process, the display picture determination unit 105 may hold difference information between a time indicating a position of a display picture when the position of the display picture has been determined and a time indicating a reference position, and determine the next reference position by setting the reference position based on the difference information.

In addition, next, the display picture determination unit 105 sets a search range based on the reference position (S115). A size of the search range may be a size corresponding to a reproduction speed. The display picture determination unit 105 determines whether or not there is a chapter within the search range (S120). Here, when the chapter is determined to be present, the display picture determination unit 105 designates a position of a chapter closest to the reference position as the display position (S125). On the other hand, when the chapter is determined to be absent, then the display picture determination unit 105 determines whether or not there is feature quantity information regarding a picture in the search range (S130). When the feature quantity information is determined to be present in the search range, the display picture determination unit 105 determines a display position based on a feature quantity (S135). On the other hand, if the feature quantity information is determined to be absent in the search range, the display picture determination unit 105 designates a reference position as the display position (S140).

When the display position is determined as described above, then the display picture determination unit 105 selects the display picture based on the display position (S145). The display picture determination unit 105 generates information for specifying the selected display picture, the code supply control unit 115 supplies code data based on the information, the de-multiplexing control unit 120 de-multiplexes the code data, the decoding control unit 130 causes the de-multiplexed data to be decoded, and the display control unit 140 causes the decoded data to be displayed, and hence a display picture is output (S150).

Next, the display picture determination unit 105 determines whether or not the display picture has been determined up to an end of content (S155). When it is determined that the display picture has been determined up to the end of content, the display picture determination process ends. On the other hand, when it is determined that the display picture has not been determined up to the end of content, the process from step 5100 is iterated.

### 4. EXAMPLE OF EFFECTS

As described above, after a reference position has been determined at time intervals corresponding to a reproduction speed, it is possible to display a more important scene without impairing a time-series sense by determining a display picture based on metadata of content in the vicinity of a reference position.

Recently, opportunities for users to view and listen to video content has increased according to the spread of smart phones and tablets and an increase in opportunities to obtain video content via a network. If an amount of video content increases, it is difficult for a user to search for and view and listen to content suitable for the user's preference. Under this situation, an automatic picture recording function based on a keyword or the user's preference or a content recommendation function has become widespread. In addition, a technique of allowing a friend or the like to recommend content suitable for a user's preference from enormous video content in a social network or the like has been established.

Incidentally, the above-described technique is technology for allowing a user to efficiently recommend content suitable for a preference in units of content, and does not shorten a viewing/listening time of content itself. In addition, in order to check whether extracted content is really suitable for a user's preference, the user actually reproduces and checks details of the content. A method of shortening the viewing/listening time of the content is necessary.

As the method of shortening the viewing/listening time of content, for example, there are a commercial message (CM) skip function, a quick reproduction function, a digest reproduction function, a fast forward (fast rewind) function, and the like. Incidentally, because it is difficult to skip main content in the CM skip function, an effect of shortening the viewing/listening time is weak. In addition, because the quick reproduction function has about a double speed even when a reproduction speed is high, the effect of shortening the viewing/listening time is limited. Here, the quick reproduction function refers to a high-speed reproduction function with sound. In addition, the digest reproduction function mainly uses feature quantities of a video and audio. Thus, a time-axis sense of content is lost. In addition, it is not necessarily possible to recognize details of content. A skipped featureless section is not necessarily a scene the user does not have to view. For example, when a kick-off scene of a video of a soccer game is determined to be a featureless scene, the kick-off scene the user wants to view may be omitted. In addition, even when a scene with a favorite celebrity is desired to be viewed, the scene may be omitted if a feature quantity is low. In addition, in existing high-speed reproduction (fast forward or rewind), a display position is determined at predetermined time intervals regardless of details of content. Thus, because unrelated pictures are displayed in sequence when the reproduction speed is high, it is difficult to recognize details of content.

On the other hand, according to a method proposed in the present disclosure, it is possible to display a more important scene without impairing a time-series sense by determining a display picture based on metadata of content in the vicinity of a reference position after determining the reference position at time intervals corresponding to a reproduction speed as described above. Thereby, the present disclosure can have the following effects.

Searchability of a position desired to be viewed is improved.

Viewing/listening is possible by skipping a position not desired to be viewed.

It is possible not only to shorten a reproduction time, but also to easily recognize details of content.

It is easy to recognize a reproduction position on the time axis within content.

It is possible to reduce content according to the user's demand.

In addition, the following effects can be expected according to the above-described reproduction method.

It is possible to view and listen to more video content in the same time.

It is possible to increase an opportunity to view and listen to video content.

It is possible to provide an incentive to record and buy video content.

There is an opportunity to expand a simple test viewing/listening service.

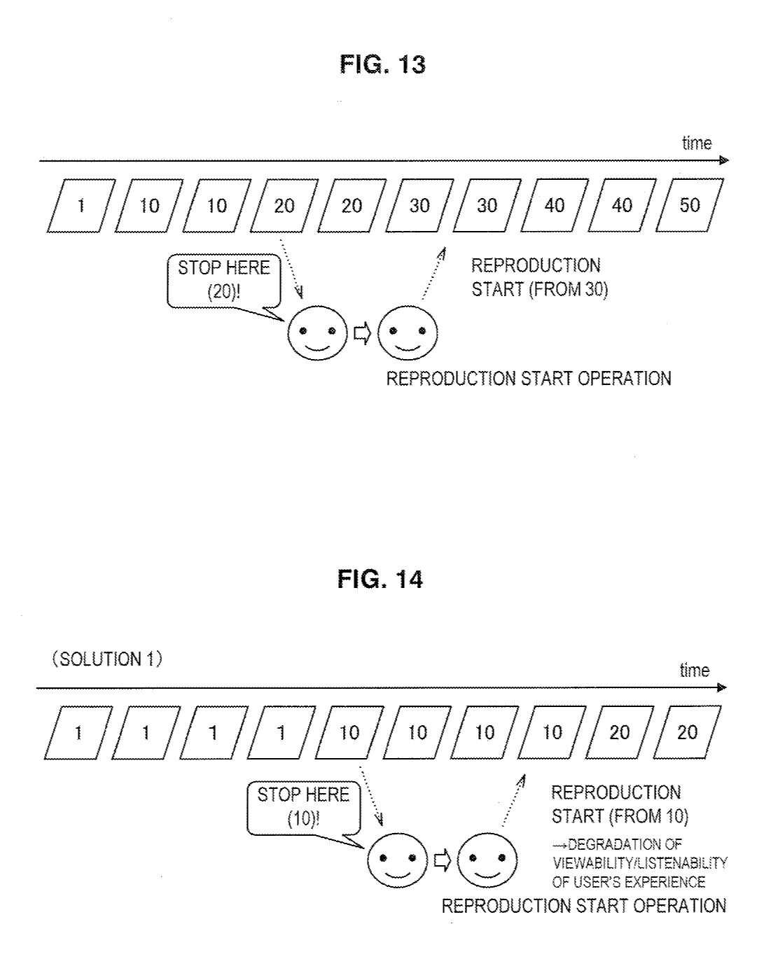

In addition, the present disclosure has effects to be described next using FIGS. 13 to 16 by providing a continuous display section in a display picture.

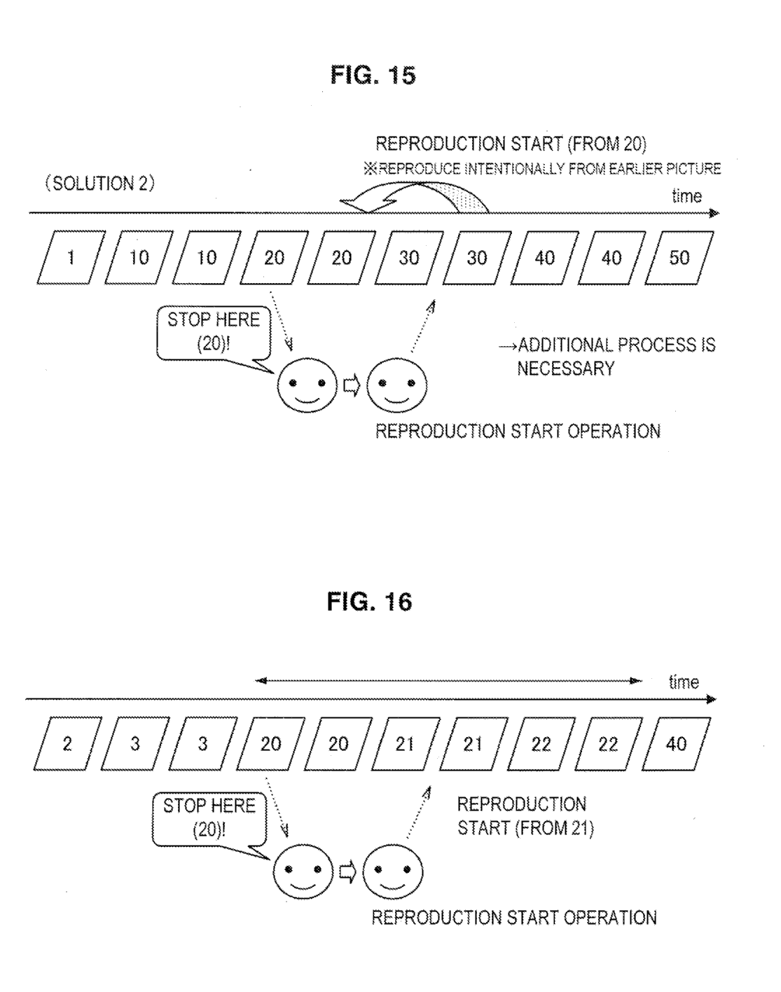

FIG. 13 is an explanatory diagram illustrating an example of a situation occurring when reproduction at a normal reproduction speed is started from high-speed reproduction. FIG. 14 is an explanatory diagram illustrating solution 1 for resolving the same situation. FIG. 15 is an explanatory diagram illustrating solution 2 for resolving the same situation. FIG. 16 is an explanatory diagram illustrating a situation when reproduction at a normal reproduction speed is started from high-speed reproduction in the information processing apparatus in accordance with the same embodiment.

Referring to FIG. 13, reproduction may actually start from a picture (30) when a display picture is determined at constant intervals, for example, when a viewer views a picture (20) and performs a reproduction start operation to indicate that “reproduction is desired to be performed at a normal speed from here.” As solution 1 for this situation, for example, as illustrated in FIG. 14, a process of delaying switching of a picture is considered. That is, the same picture is displayed for a long time. In this case, when the viewer views a picture (10) and performs a reproduction start operation, reproduction may start from the desired picture (10). However, viewability/listenability of the user's experience may be degraded.

In addition, as in solution 2 illustrated in FIG. 15, a process of starting reproduction from a picture before a point in time at which the reproduction start operation has been intentionally sensed is considered. Incidentally, an additional process is necessary in this method. The information processing apparatus in accordance with the embodiment of the present disclosure displays a plurality of adjacent pictures by providing a continuous display section. Thereby, even when there is a difference from when the viewer has intended to perform the reproduction start operation to when the reproduction start operation is actually sensed, reproduction can start from an adjacent picture. At this time, because a plurality of pictures are displayed, the remaining time becomes long at a near time. However, because there is motion in a picture, it is possible to reduce the degradation of viewability/listenability of the user's experience.

### 5. MODIFIED EXAMPLES

While preferred embodiments of the present disclosure have been described above in detail with reference to the accompanying drawings, the present disclosure is not limited to the embodiments. It should be understood by those skilled in the art that various modifications, combinations, sub-combinations, and alterations may occur depending on design requirements and other factors insofar as they are within the scope of the appended claims or the equivalents thereof.

Although the display picture determination process is performed in parallel with high-speed reproduction, for example, in the above-described embodiment, the present technology is not limited to this embodiment. For example, a display picture determination apparatus, which determines a display picture corresponding to a reproduction speed in advance, and a display control apparatus may be separate apparatuses. The information processing apparatus has a transmission unit (not illustrated), and information of a picture selected by a display picture determination unit is transmitted from the transmission unit to the display control apparatus.

In addition, although the case in which the display control apparatus and the display apparatus are separate apparatuses has been described in the above-described embodiment, the present technology is not limited to this embodiment. For example, the present technology can also be applied to the information processing apparatus in which the display apparatus has been embedded.

In addition, although content to be reproduced is recorded program content in the above-described embodiment, the present technology is not limited to this embodiment. For example, the content to be reproduced may be video content stored in a storage medium. Alternatively, the content to be reproduced is moving-picture content supplied via a network.

In the present specification, the steps describing the program recorded on the recording medium include not only processes to be performed in time series in the described order, but also processes to be performed in parallel or individually even when the processes are not necessarily processed in time series. Of course, it is possible to appropriately change the order, if necessary, even for the steps processed in time series.

Although the case in which the information processing apparatus serving as a content reproduction control apparatus is a recording/reproducing apparatus has been described in the above-described embodiment, the present technology is not limited to this embodiment. For example, the information processing apparatus may be an information processing apparatus such as a PC, a home video processing apparatus (a DVD recorder, a video cassette recorder, or the like), a personal digital assistant (PDA), a home game machine, a home appliance, or the like. In addition, the information processing apparatus may be an information processing apparatus such as a portable phone, a personal handy-phone system (PHS), a portable audio reproduction device, a portable video processing device, a portable game machine, or the like. It is desirable that the information processing apparatus have a function of reproducing video content.

In addition, when the display picture information generation apparatus and the display control apparatus as described above are separate apparatuses, the picture information generation apparatus of the information processing apparatus described in the above-described embodiment can function as an apparatus separate from the display control apparatus. In this case, the picture information generation apparatus may not have a function of reproducing video content.

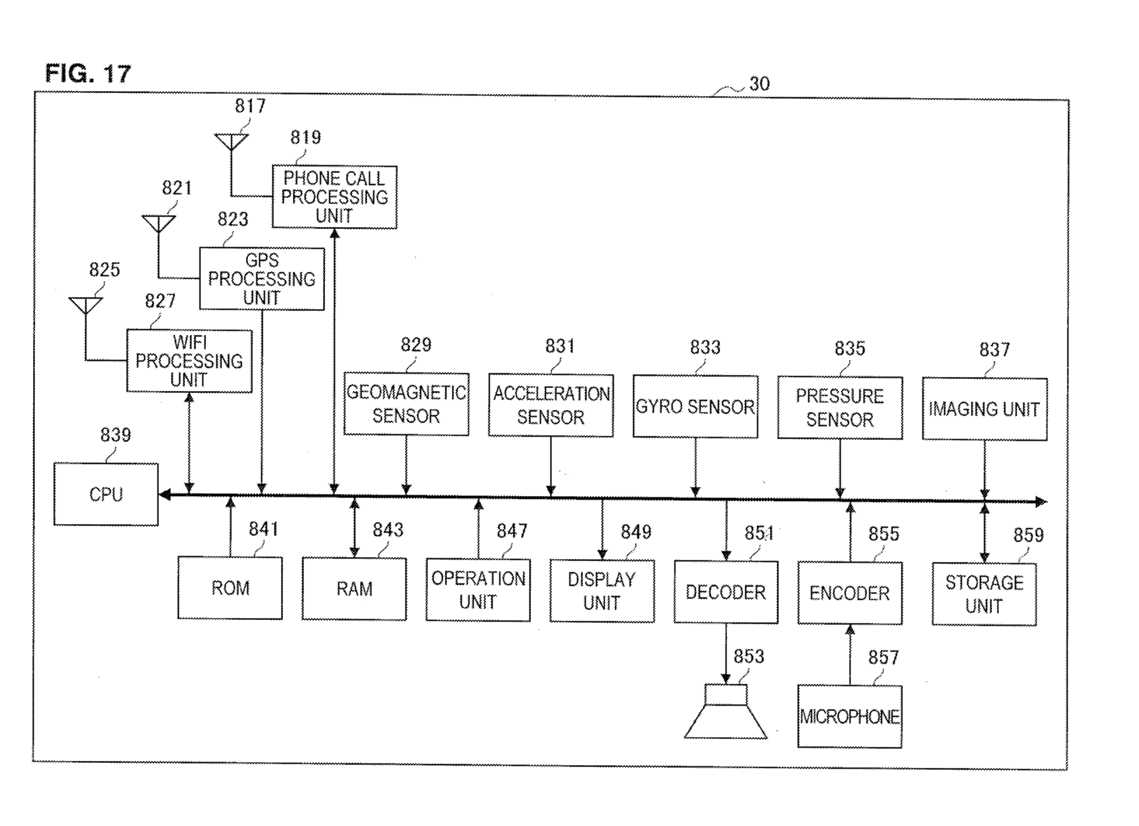

Hereinafter, an example of a hardware configuration when the information processing apparatus is a portable phone will be described with reference to FIG. 17. FIG. 17 is a block diagram illustrating an example of a hardware configuration when the information processing apparatus is the portable phone in accordance with an embodiment of the present disclosure.

Here, an example of a configuration of a portable phone 30 will be described. Referring to FIG. 17, the portable phone 30, for example, includes a phone network antenna 817, a phone call processing unit 819, a global positioning system (GPS) antenna 821, a GPS processing unit 823, a wireless fidelity (WiFi) antenna 825, a WiFi processing unit 827, a geomagnetic sensor 829, an acceleration sensor 831, a gyro sensor 833, a pressure sensor 835, an imaging unit 837, a central processing unit (CPU) 839, a read only memory (ROM) 841, a random access memory (RAM) 843, an operation unit 847, a display unit 849, a decoder 851, a speaker 853, an encoder 855, a microphone 857, and a storage unit 859. The hardware configuration shown here is one example, and some elements may be omitted. In addition, of course, elements other than the elements shown here may be further included.

### (Phone Network Antenna 817)

The phone network antenna 817 is an example of an antenna having a function of establishing a wireless connection to a portable phone network for a phone call and communication. The phone network antenna 817 can supply a phone call signal received via a portable phone network to the phone call processing unit 819.

### (Phone Call Processing Unit 819)

The phone call processing unit 819 has a function of performing various signal processings on a signal transmitted/received by the phone network antenna 817. The phone call processing unit 819, for example, can perform various signal processings on an audio signal encoded by the encoder 855 input via the microphone 857, and supply the processing result to the phone network antenna 817. In addition, the phone call processing unit 819 can perform various signal processings on an audio signal supplied from the phone network antenna 817 and supplies the processing result to the decoder 851.

### (GPS Antenna 821)

The GPS antenna 821 is an example of an antenna that receives a signal from a positioning satellite. The GPS antenna 821 can receive GPS signals from a plurality of GPS satellites and input the received signals to the GPS processing unit 823.

### (GPS Processing Unit 823)

The GPS processing unit 823 is an example of a calculation unit that calculates position information based on a signal received from the positioning satellite. The GPS processing unit 823 calculates current position information based on a plurality of GPS signals input from the GPS antenna 821, and outputs the calculation position information. Specifically, the GPS processing unit 823 calculates a position of each GPS satellite from orbital data of the GPS satellites, and calculates a distance from each GPS satellite to the portable phone 30 based on a difference time between a transmission time and a reception time of a GPS signal. It is possible to calculate a current three-dimensional (3D) position based on the calculated position of each GPS satellite and the distance from each GPS satellite to the portable phone 30. The orbital data of the GPS satellites used here, for example, may be included in the GPS signal. Alternatively, the orbital data of the GPS satellites may be acquired from an external server via the WiFi antenna 825.

### (WiFi Antenna 825)

The WiFi antenna 825, for example, is an antenna having a function of transmitting/receiving a communication signal to/from a local area network (LAN) communication network according to a WiFi specification. The WiFi antenna 825 can supply the received signal to the WiFi processing unit 827.

### (WiFi Processing Unit 827)

The WiFi processing unit 827 has a function of performing various signal processings on a signal supplied from the WiFi antenna 825. The WiFi processing unit 827 can supply a digital signal generated from a supplied analog signal to the CPU 839.

### (Geomagnetic Sensor 829)

The geomagnetic sensor 829 is a sensor that detects geomagnetism as a voltage value. The geomagnetic sensor 829 may be a triaxial geomagnetic sensor that detects geomagnetism of each of X-, Y-, and Z-axis directions. The geomagnetic sensor 829 can supply detected geomagnetic data to the CPU 839.

### (Acceleration Sensor 831)

The acceleration sensor 831 is a sensor that detects acceleration as a voltage value. The acceleration sensor 831 may be a triaxial acceleration sensor that detects each of acceleration along the X-axis direction, acceleration along the Y-axis direction, and acceleration along the Z-axis direction. The acceleration sensor 831 can supply detected acceleration data to the CPU 839.

### (Gyro Sensor 833)

The gyro sensor 833 is a type of measurer that detects an angle or angular velocity of an object. This gyro sensor 833 may be a triaxial gyro sensor that detects a velocity (angular velocity) at which a rotation angle changes around X, Y, and Z axes as a voltage value. The gyro sensor 833 can supply detected angular velocity data to the CPU 839.

### (Pressure Sensor 835)

The pressure sensor 835 is a sensor that detects a surrounding pressure as a voltage value. The pressure sensor 835 can detect the pressure at a predetermined sampling frequency, and supply detected pressure data to the CPU 839.

### (Imaging Unit 837)

The imaging unit 837 has a function of capturing a still-picture or a moving-picture via a lens according to control of the CPU 839. The imaging unit 837 may store the captured picture in the storage unit 859.

### (CPU 839)

The CPU 839 functions as a calculation processing apparatus and a control apparatus, and controls the general operation within the portable phone according to various programs. In addition, the CPU 839 may be a microprocessor. The CPU 839 can implement various functions according to various programs.

### (ROM 841 and RAM 843)

The ROM 841 can store programs, calculation parameters, and the like to be used by the CPU 839. The RAM 843 can temporarily store programs to be used for execution of the CPU 839, parameters that appropriately change in the execution thereof, and the like.

### (Operation Unit 847)

The operation unit 847 has a function of generating an input signal for allowing the user to perform a desired operation. The operation unit 847, for example, may include an input unit for allowing the user to input information such as a touch sensor, a mouse, a keyboard, a button, a microphone, a switch, or a lever, an input control circuit for generating an input signal based on an input by the user and outputting the generated input signal to the CPU 839, and the like.

### (Display Unit 849)

The display unit 849 is an example of an output apparatus, and may be a display apparatus such as a liquid crystal display (LCD) apparatus, an organic electroluminescence (EL) (organic light emitting diode (OLED)) display apparatus, or the like. The display unit 849 can provide information by displaying a screen for the user.

### (Decoder 851 and Speaker 853)

The decoder 851 has a function of performing decoding, analog conversion, and the like on input data according to control of the CPU 839. The decoder 851, for example, can perform decoding, analog conversion, and the like on audio data input via the phone network antenna 817 and the phone call processing unit 819, and output an audio signal to the speaker 853. In addition, the decoder 851, for example, performs decoding, analog conversion, and the like on audio data input via the WiFi antenna 825 and the WiFi processing unit 827, and outputs an audio signal to the speaker 853. The speaker 853 can output an audio based on the audio signal supplied from the decoder 851.

### (Encoder 855 and Microphone 857)

The encoder 855 has a function of performing digital conversion, encoding, and the like on input data according to control of the CPU 839. The encoder 855 can perform digital conversion, encoding, and the like on an audio signal input from the microphone 857, and output audio data. The microphone 857 can collect an audio and output the collected audio as the audio signal.

### (Storage Unit 859)

The storage unit 859 is a data storage apparatus, and can include a storage medium, a recording apparatus, which records data on the storage medium, a reading apparatus, which reads data from the storage medium, a deleting apparatus, which deletes data recorded on the storage medium, and the like. Here, for example, a non-volatile memory such as a flash memory, an MRAM, an FeRAM, a PRAM, or an EEPROM and a magnetic recording medium such as an HDD may be used as the storage medium.

The portable phone 30 can function as a display picture information generation apparatus by implementing a function of the display picture determination unit 105 according to the above-described hardware configuration. Alternatively, the portable phone 30 can function as the display control apparatus by implementing a function of the reproduction control unit 100 that reproduces content based on display picture information according to the above-described hardware configuration. This embodiment also belongs to a technical range of the present disclosure. According to the configuration of the portable phone 30 shown here, the above-described process, for example, can be performed on content acquired from an external server connected via the phone network antenna 817 and the phone call processing unit 819 or the WiFi antenna 825 and the WiFi processing unit 827. In addition, although not illustrated in FIG. 17, when the portable phone 30 has a configuration that receive broadcast waves, the portable phone 30 can function as a display picture generation apparatus that generates display picture information on content received by the broadcast waves or a display control apparatus that reproduces content.

Additionally, the present technology may also be configured as below.

(1) An information processing apparatus including:

a reference position determination unit configured to determine a reference position on a time axis in content reproduction at time intervals corresponding to a reproduction speed of content;

a search range setting unit configured to set a search range on the time axis based on the reference position; and

a selection unit configured to select a display picture to be displayed in the content reproduction based on metadata of the content in each search range.

(2) The information processing apparatus according to (1), wherein the selection unit selects a plurality of the display pictures in the search range.

(3) The information processing apparatus according to (1) or (2), wherein the search range setting unit sets the search range having a size based on the reproduction speed.

(4) The information processing apparatus according to (3), wherein the search range setting unit sets the search range that is larger as the reproduction speed is higher.

(5) The information processing apparatus according to any one of (1) to (4), wherein the metadata includes information of a chapter point set in the content.

(6) The information processing apparatus according to any one of (1) to (5), wherein the metadata includes information of a feature quantity of the content.

(7) The information processing apparatus according to any one of (1) to (6),

wherein the metadata includes information of a feature quantity of the content and a chapter point, and

wherein the selection unit selects the display picture by providing priority to the information of the chapter point rather than the feature quantity.

(8) The information processing apparatus according to any one of (1) to (7), further including:

a reproduction control unit configured to cause the selected display picture to be reproduced.

(9) The information processing apparatus according to any one of (1) to (8), further including:

a display control unit configured to cause the selected display picture to be displayed.

(10) The information processing apparatus according to any one of (1) to (9), further including:

a transmission unit configured to transmit the selected display picture.

(11) An information processing method including:

determining a reference position on a time axis in content reproduction at time intervals corresponding to a reproduction speed of content;

setting a search range on the time axis based on the reference position; and

selecting a display picture to be displayed in the content reproduction based on metadata of the content in each search range.

(12) A program for causing a computer to function as an information processing apparatus, which includes:

a reference position determination unit configured to determine a reference position on a time axis in content reproduction at time intervals corresponding to a reproduction speed of content;

a search range setting unit configured to set a search range on the time axis based on the reference position; and

a selection unit configured to select a display picture to be displayed in the content reproduction based on metadata of the content in each search range.

(13) An information processing apparatus including:

a time interval setting unit configured to set a time interval on a time axis of video data based on a reproduction speed of the video data;

a search range setting unit configured to set a plurality of search ranges on the time axis of the video data based on the time interval; and

a reproduction unit configured to sequentially reproduce the video data present in the plurality of search ranges based on metadata of the video data.

(14) The information processing apparatus according to (13), wherein the search range setting unit sets the search range having a size based on the reproduction speed.

(15) The information processing apparatus according to (14), wherein the search range setting unit sets the search range that is larger as the reproduction speed is higher.

(16) An information processing method including:

setting a time interval on a time axis of video data based on a reproduction speed of the video data;

setting a plurality of search ranges on the time axis of the video data based on the time interval; and

sequentially reproducing the video data present in the plurality of search ranges based on metadata of the video data.

(17) A program for causing a computer to execute a process including the steps of:

setting a time interval on a time axis of video data based on a reproduction speed of the video data;

setting a plurality of search ranges on the time axis of the video data based on the time interval; and

sequentially reproducing the video data present in the plurality of search ranges based on metadata of the video data.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-017934 filed in the Japan Patent Office on Jan. 31, 2012, the entire content of which is hereby incorporated by reference.

What is claimed is:

1. An information processing apparatus comprising:
a reference position determination unit configured to determine a reference position on a time axis in content reproduction at time intervals corresponding to a reproduction speed of content;
a search range setting unit configured to set a search range on the time axis based on the reference position; and
a selection unit configured to select a display picture to be displayed in the content reproduction based on metadata of the content in each search range.

2. The information processing apparatus according to claim 1, wherein the selection unit selects a plurality of the display pictures in the search range.

3. The information processing apparatus according to claim 1, wherein the search range setting unit sets the search range having a size based on the reproduction speed.

4. The information processing apparatus according to claim 3, wherein the search range setting unit sets the search range that is larger as the reproduction speed is higher.

5. The information processing apparatus according to claim 1, wherein the metadata includes information of a chapter point set in the content.

6. The information processing apparatus according to claim 1, wherein the metadata includes information of a feature quantity of the content.

7. The information processing apparatus according to claim 1,
wherein the metadata includes information of a feature quantity of the content and a chapter point, and
wherein the selection unit selects the display picture by providing priority to the information of the chapter point rather than the feature quantity.

8. The information processing apparatus according to claim 1, further comprising:
a reproduction control unit configured to cause the selected display picture to be reproduced.

9. The information processing apparatus according to claim 1, further comprising:
a display control unit configured to cause the selected display picture to be displayed.

10. The information processing apparatus according to claim 1, further comprising:
a transmission unit configured to transmit the selected display picture.

11. An information processing method comprising:
determining a reference position on a time axis in content reproduction at time intervals corresponding to a reproduction speed of content;
setting a search range on the time axis based on the reference position; and
selecting a display picture to be displayed in the content reproduction based on metadata of the content in each search range.

12. A program for causing a computer to function as an information processing apparatus, which includes:
a reference position determination unit configured to determine a reference position on a time axis in content reproduction at time intervals corresponding to a reproduction speed of content;
a search range setting unit configured to set a search range on the time axis based on the reference position; and
a selection unit configured to select a display picture to be displayed in the content reproduction based on metadata of the content in each search range.

13. An information processing apparatus comprising:
a time interval setting unit configured to set a time interval on a time axis of video data based on a reproduction speed of the video data;
a search range setting unit configured to set a plurality of search ranges on the time axis of the video data based on the time interval; and
a reproduction unit configured to sequentially reproduce the video data present in the plurality of search ranges based on metadata of the video data.

14. The information processing apparatus according to claim 13, wherein the search range setting unit sets the search range having a size based on the reproduction speed.

15. The information processing apparatus according to claim 14, wherein the search range setting unit sets the search range that is larger as the reproduction speed is higher.

16. An information processing method comprising:
setting a time interval on a time axis of video data based on a reproduction speed of the video data;
setting a plurality of search ranges on the time axis of the video data based on the time interval; and
sequentially reproducing the video data present in the plurality of search ranges based on metadata of the video data.

17. A program for causing a computer to execute a process including the steps of:
setting a time interval on a time axis of video data based on a reproduction speed of the video data;
setting a plurality of search ranges on the time axis of the video data based on the time interval; and
sequentially reproducing the video data present in the plurality of search ranges based on metadata of the video data.
